(19) United States
(12) Patent Application Publication
(10) Pub. No.: US 2026/0193546 A1
(43) Pub. Date: Jul. 9, 2026

(54) METHODS FOR CO-PROCESSING CRUDE OILS WITH COOKING OILS

(71) Applicant: Saudi Arabian Oil Company, Dhahran (SA)

(72) Inventors: Aaron Chi Akah, Dhahran (SA); Mansour Ali Al Herz, Al Ahsa (SA); Rashed Aleisa, Dhahran (SA); Bandar Khalid Alotaibi, Dammam (SA)

(73) Assignee: Saudi Arabian Oil Company, Dhahran (SA)

(21) Appl. No.: 19/009,452

(22) Filed: Jan. 3, 2025

(51) Int. Cl. C10G 11/18; B01J 29/40; B01J 29/80; C10G 11/05

(52) U.S. Cl. CPC C10G 11/18; B01J 29/40; B01J 29/80; C10G 11/05; B01J 2229/42; C10G 2300/1007; C10G 2300/1033; C10G 2300/301; C10G 2300/308; C10G 2300/4006; C10G 2400/20

(57) ABSTRACT

Described herein are embodiments where crude oil and cooking oil may be co-processed in a method that includes catalytically cracking a hydrocarbon mixture to form hydrocarbon product. The hydrocarbon mixture may include from 1 wt. % to 20 wt. % of cooking oil and from 80 wt. % to 99 wt. % of crude oil having an API gravity of from 30° to 38°. The hydrocarbon product may include ethylene, propylene, and butenes.

### TECHNICAL FIELD

Embodiments of the present disclosure generally relate to chemical processing and, more specifically, to methods and systems utilized in the processing of hydrocarbons into light olefins.

### BACKGROUND

Crude oils may be processed by cracking to form upgraded chemicals. In particular, light olefins may be desirable products for such cracking reactions, as they are higher in value and utilized in many downstream processes. For example, light olefins may be utilized as circular chemicals, as well as many other use cases throughout the petrochemical industry. Such circular chemicals may be re-processed and be considered more environmentally friendly. As such, new methods for making such materials, including light olefins, are desired by industry.

### BRIEF SUMMARY

Embodiments of the present disclosure provide, according to one or more embodiments, methods of co-processing crude oil along with cooking oil in a shared cracking reactor. Unexpectedly, it has been discovered that utilizing cooking oil in combination with crude oil, even in relatively small amounts as compared with the crude oil (e.g., 10 wt. %), forms increased amounts of light olefins (i.e., ethylene, ethylene, and butenes) than would otherwise be expected based on the amounts of crude oil and cooking oil. Such a synergistic effect is new and beneficial for the chemical industry.

According to one or more embodiments, crude oil and cooking oil may be co-processed in a method that comprises catalytically cracking a hydrocarbon mixture to form hydrocarbon product. The hydrocarbon mixture may comprise from 1 wt. % to 20 wt. % of cooking oil and from 80 wt. % to 99 wt. % of crude oil having an API gravity of from 30° to 38°. The hydrocarbon product may comprise ethylene, propylene, and butenes.

These and other embodiments are described in more detail in the Detailed Description. It is to be understood that both the foregoing general description and the following detailed description present embodiments of the presently disclosed technology, and are intended to provide an overview or framework for understanding the nature and character of the technology as it is claimed. The accompanying drawings are included to provide a further understanding of the presently disclosed technology and are incorporated into and constitute a part of this specification. The drawings illustrate various embodiments and, together with the description, serve to explain the principles and operations of the presently disclosed technology. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 depicts a generalized schematic diagram of an embodiment of a fluid catalytic cracking reactor unit, according to one or more embodiments described in this disclosure;

FIG. 2 depicts a generalized schematic diagram of system that include a cracker and a downstream separation unit, according to one or more embodiments described in this disclosure; and

FIG. 3 depicts example data showing conversion of various feeds including cooking oil, crude oil, and a mixture thereof, according to one or more embodiments described in this disclosure.

For the purpose of describing the simplified schematic illustrations and descriptions of the relevant figures, the numerous valves, temperature sensors, electronic controllers and the like that may be employed and well known to those of ordinary skill in the art of certain chemical processing operations are not included. Further, accompanying components that are often included in typical chemical processing operations, such as air supplies, catalyst hoppers, and flue gas handling systems, are not depicted. However, operational components, such as those described in the present disclosure, may be added to the embodiments described in this disclosure.

It should further be noted that arrows in the drawings refer to process streams. However, the arrows may equivalently refer to transfer lines which may serve to transfer process streams between two or more system components. Additionally, arrows that connect to system components define inlets or outlets in each given system component. The arrow direction corresponds generally with the major direction of movement of the materials of the stream contained within the physical transfer line signified by the arrow. Furthermore, arrows which do not connect two or more system components signify a product stream which exits the depicted system or a system inlet stream which enters the depicted system. Product streams may be further processed in accompanying chemical processing systems or may be commercialized as end products. System inlet streams may be streams transferred from accompanying chemical processing systems or may be non-processed feedstock streams. Some arrows may represent recycle streams, which are effluent streams of system components that are recycled back into the system. However, it should be understood that any represented recycle stream, in some embodiments, may be replaced by a system inlet stream of the same material, and that a portion of a recycle stream may exit the system as a system product.

Additionally, arrows in the drawings may schematically depict process steps of transporting a stream from one system component to another system component. For example, an arrow from one system component pointing to another system component may represent “passing” a system component effluent to another system component, which may include the contents of a process stream “exiting” or being “removed” from one system component and “introducing” the contents of that product stream to another system component. It should be understood that arrows in the relevant figures are not indicative of necessary or essential steps.

It should be understood that according to the embodiments presented in the relevant figures, an arrow between two system components may signify that the stream is not processed between the two system components. In other embodiments, the stream signified by the arrow may have substantially the same composition throughout its transport between the two system components. Additionally, it should be understood that in one or more embodiments, an arrow may represent that at least 75 wt. %, at least 90 wt. %, at least 95 wt. %, at least 99 wt. %, at least 99.9 wt. %, or even 100 wt. % of the stream is transported between the system components. As such, in some embodiments, less than all of the streams signified by an arrow may be transported between the system components, such as if a slip stream is present.

It should be understood that two or more process streams are “mixed” or “combined” when two or more lines intersect in the schematic flow diagrams of the relevant figures. Mixing or combining may also include mixing by directly introducing both streams into a like reactor, separation device, or other system component. For example, it should be understood that when two streams are depicted as being combined directly prior to entering a separation unit or reactor, that in some embodiments the streams could equivalently be introduced into the separation unit or reactor and be mixed in the reactor.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

One or more embodiments of the present disclosure relate to methods for co-processing crude oils and cooking oils in a common cracking process, such as by co-injecting the crude oil and cooking oil into a cracking reactor, or by co-injecting such as a mixed stream. As described herein, the cooking oil and crude oil may be in relative amounts to one another, and the specific type of crude oil and/or cooking oil may be desired, according to various embodiments. In some embodiments, the cooking oil utilized may be used cooking oil that has been used in cooking operations, and is otherwise a waste product of such cooking operations. Additionally, in some embodiments, the crude oil may have an API gravity or chemical composition similar to or identical to that of Arab Light crude oil.

Without by being bound by any particular theory, it has been observed that co-cracking cooking oil and crude oil may result in increased amounts of desirable products such as light olefins. As is described herein, cooking oils, when cracked, may yield relatively more light olefins than crude oils, such as Arab Light crude oil. Thus, a mixture of crude oil and cooking oil would be expected to yield greater amounts of light olefins when cracked than crude oil on its own. Such a result would not have any real value, as the two components could be separately processed. However, very surprisingly, it is now discovered that the relative amount of light olefins produced by cracking a mixture of crude oil and cooking oil is greater than would be expected. As is shown in the Examples which follow, in some particular embodiments, a non-linear relationship in the amount of light olefins produced is observed based on the ratio of cooking oil to crude oil, showing that the yield of light olefins is positively influenced by having the crude oil and cooking oil mixed while being cracked.

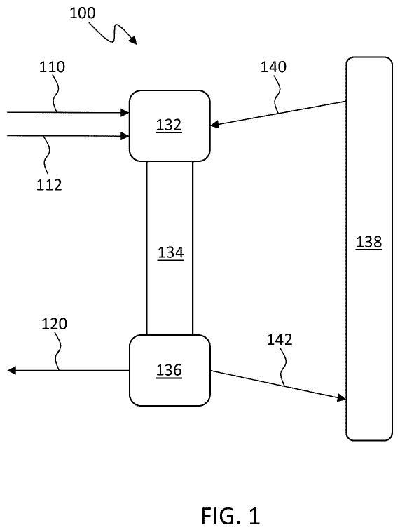

It is contemplated that a wide variety of processing systems may be utilized to practice the methods currently described. FIG. 1 schematically depicts one such embodiment, a fluid catalytic cracking reactor unit which may be utilized in converting the co-fed crude oil and cooking oil into a hydrocarbon product 120. The embodiment of FIG. 1 includes cracking catalyst regeneration functionality. The methods disclosed herein will be described in the context of FIG. 1, but other embodiments besides utilizing the reactor unit of FIG. 1 are contemplated, and the present disclosures should not be construed as narrowed by their description with respect to FIG. 1, which is used as an aid for the person skilled in the art to comprehend the entire breath of the present disclosure.

FIG. 1 schematically depicts a fluid catalytic cracking reactor unit 100 which converts crude oil and crude oil (present sometimes in streams 110, 112) into a hydrocarbon product 120. According to one or more embodiments, the reactor unit used to process the crude oil and cooking oil may be a fluid catalytic cracking (“FCC”) reactor unit. As used in this disclosure, a fluid catalytic cracking reactor unit refers to a reactor unit that can be operable to contact a fluidized solid catalyst with feed. As described in this disclosure, a fluidized bed reactor which cracks a reactant stream (such as the cooking oil and/or crude oil) with a fluidized solid cracking catalyst may be referred to as a fluid catalytic cracking reactor unit.

Still referring to FIG. 1, the crude oil may be passed to a fluid catalytic cracking reactor unit 100 via stream 110, and the cooking oil may be passed to the fluid catalytic cracking reactor unit 100 via stream 112. While depicted as separate streams 110, 112, in some embodiments a single stream may be passed to the fluid catalytic cracking reactor unit 100 that includes both the crude oil and the cooking oil. The mixture of crude oil and cooking oil, either in a stream passed into the fluid catalytic cracking reactor unit 100 or the mixture of the two once inside the fluid catalytic cracking reactor unit 100 may sometimes be referred to as a “hydrocarbon mixture.”

The fluid catalytic cracking reactor unit 100 may include a cracking catalyst/feed mixing zone 132, a reaction zone 134, a separation zone 136, and a cracking catalyst regeneration zone 138. The crude oil in stream 110 and cooking oil in stream 112 may be introduced to the cracking catalyst/feed mixing zone 132 where it is mixed with regenerated cracking catalyst from regenerated catalyst stream 140 passed from the cracking catalyst regeneration zone 138. The crude oil in stream 110 and cooking oil in stream 112 is reacted by contact with the regenerated cracking catalyst in the reaction zone 134, which cracks the crude oil and cooking oil. Following the cracking reaction in the reaction zone 134, the contents of the reaction zone 134 are passed to the separation zone 136 where the cracked product of the reaction zone 134 is separated from spent catalyst, which is passed in a spent catalyst stream 142 to the cracking catalyst regeneration zone 138 where it is regenerated by, for example, removing coke from the spent cracking catalyst if coke was created in the reaction. Alternatively, if little or no coke is created, the regeneration process may comprise heating the catalyst by, for example, burning a combustible fuel. The hydrocarbon product 120 is passed from the fluid catalytic cracking reactor unit, where it may be further processed, for example by separation into multiple streams.

It should be understood that fluid catalytic cracking reactor unit 100 of FIG. 1 is a simplified schematic of one particular embodiment of a fluid catalytic cracking reactor unit, and other configurations of fluid catalytic cracking reactor units may be suitable for the presently disclosed hydrocarbon cracking methods. For example, in some embodiments, the catalyst may not be recycled, and in such embodiments, the components of FIG. 1 related to the regeneration of the cracking catalyst would not be present. According to one or more embodiments, a method for processing a crude oil and cooking oil may comprise contacting the crude oil and cooking oil with a catalyst to form a hydrocarbon product. The catalyst may be fluidized while contacting the crude oil and cooking oil. For example, the catalyst may be contacted with the crude oil and cooking oil (i.e., the hydrocarbon mixture) in a fluid catalytic cracking reactor unit 100 operating at elevated temperatures, such as from 600° C. to 700° C. The catalyst to oil mass ratio (based on the sum of the crude oil and cooking oil) may be from 40:1 to 1:1, such as from 10:1 to 1:1, or such as from 6:1 to 4:1.

As described in this disclosure, a “catalyst” refers to any substance which increases the rate of a specific chemical reaction. Catalysts described in this disclosure may be utilized to promote various reactions, such as, but not limited to, cracking of hydrocarbons, such as by fluidized catalytic cracking (FCC). It is contemplated that a wide variety of cracking catalysts may be used, such as, without limitation, zeolite based catalysts.

According to one or more embodiments, particular catalyst compositions may be utilized that increase conversion as compared with some conventional catalysts. In particular, according to one or more embodiments, the catalyst may comprise ZSM-5 zeolite and zeolite-Y, such as an ultra-stable zeolite Y (“USY”). The ZSM-5, the zeolite-Y, or both may be impregnated with a dopant such as La and/or P. The catalyst may further comprise silica, alumina, and/or clay.

According to one or more embodiments, the ZSM-5 zeolite may comprise a single composition of ZSM-5 or may be multiple ZSM-5 zeolites in combination. The amount of ZSM-5 zeolite present in the catalyst may be from 5 wt. % to 50 wt. %, based on the total weight of the catalyst. For example, the amount of ZSM-5 zeolite present in the catalyst may be from 5 wt. % to 10 wt. %, from 10 wt. % to 15 wt. %, from 15 wt. % to 20 wt. %, from 20 wt. % to 25 wt. %, from 25 wt. % to 30 wt. %, from 30 wt. % to 35 wt. %, from 35 wt. % to 40 wt. %, from 40 wt. % to 45 wt. %, from 45 wt. % to 50 wt. %, or any combination of these ranges. The silica to alumina ratio by mass of the ZSM-5 may be from 5-80, such as from 55-30, from 30-60, from 60-80, or any combination of these ranges. The surface area of the ZSM-5 may be from 200 m²/g to 800 m²/g, such as from 200 m²/g to 400 m²/g, from 400 m²/g to 600 m²/g, from 600 m²/g to 800 m²/g, or any combination of these ranges.

According to one or more embodiments, the ZSM-5 may include a dopant such as, without limitation, La₂O₃. The La₂O₃ may be impregnated into the ZSM-5 prior to the ZSM-5 being mixed with the other components to form the catalyst. In one or more embodiments, the La₂O₃ may be in amounts of from 0.5 wt. % to 10 wt. % of the weight of the ZSM-5. For example, the La₂O₃ may be in amounts of from 0.5 wt. % to 2.5 wt. %, from 2.5 wt. % to 5 wt. %, from 5 wt. % to 7.5 wt., from 7.5 wt. % to 10 wt. %, or any combination of these ranges, of the weight of the ZSM-5.

According to one or more embodiments, the zeolite-Y may comprise a single composition of zeolite-Y or may be multiple zeolite-Y zeolites in combination. The amount of zeolite-Y present in the catalyst may be from 5 wt. % to 50 wt. %, based on the total weight of the catalyst. For example, the amount of zeolite-Y present in the catalyst may be from 5 wt. % to 10 wt. %, from 10 wt. % to 15 wt. %, from 15 wt. % to 20 wt. %, from 20 wt. % to 25 wt. %, from 25 wt. % to 30 wt. %, from 30 wt. % to 35 wt. %, from 35 wt. % to 40 wt. %, from 40 wt. % to 45 wt. %, from 45 wt. % to 50 wt. %, or any combination of these ranges. The silica to alumina ratio by mass of the zeolite-Y may be from 5-80, such as from 55-30, from 30-60, from 60-80, or any combination of these ranges. The surface area of the zeolite-Y may be from 200 m²/g to 800 m²/g, such as from 200 m²/g to 400 m²/g, from 400 m²/g to 600 m²/g, from 600 m²/g to 800 m²/g, or any combination of these ranges.

According to one or more embodiments, the zeolite-Y may include a dopant such as, without limitation, P₂O₅. The P₂O₅ may be impregnated into the zeolite-Y prior to the zeolite-Y being mixed with the other components to form the catalyst. In one or more embodiments, the P₂O₅ may be in amounts of from 0.5 wt. % to 10 wt. % of the weight of the zeolite-Y. For example, the P₂O₅ may be in amounts of from 0.5 wt. % to 2.5 wt. %, from 2.5 wt. % to 5 wt. %, from 5 wt. % to 7.5 wt., from 7.5 wt. % to 10 wt. %, or any combination of these ranges, of the weight of the zeolite-Y.

According to additional embodiments, the catalyst may comprise silica, alumina, clay, or combinations thereof. The catalyst may comprise silica in an amount of from 0.5 wt. % to 10 wt. %, such as from 0.5 wt. % to 2.5 wt. %, from 2.5 wt. % to 5 wt. %, from 5 wt. % to 7.5 wt. %, from 7.5 wt. % to 10 wt. %, or any combination of these ranges, based on the total weight of the catalyst. The catalyst may comprise alumina in an amount of from 2 wt. % to 20 wt. %, such as from 2 wt. % to 5 wt. %, from 5 wt. % to 10 wt. %, from 10 wt. % to 15 wt. %, from 15 wt. % to 20 wt. %, or any combination of these ranges, based on the total weight of the catalyst. The catalyst may comprise clay, such as kaolin, in an amount of from 30 wt. % to 60 wt. %, such as from 30 wt. % to 40 wt. %, from 40 wt. % to 50 wt. %, from 50 wt. % to 60 wt. %, or any combination of these ranges, based on the total weight of the catalyst.

According to one or more embodiments, the catalyst may be formed by a process that includes (1) ZSM-5 zeolites being impregnated with phosphorous and Y zeolites being impregnated with lanthanum; (2) mixing The impregnated zeolites with alumina binder, silica and clay and stirring for a time sufficient for mixing such as from 15 minutes to 2 hours; (3) placing the obtained slurry in a temperature programmed oven for drying and calcination; (4) grounding the catalyst to fine powder by, for example, a mortar and a pestle; and (5) sieving the grounded catalyst for a fraction from 40-120 microns.

According to one or more embodiments described herein, cooking oil may refer to any oil that is suitable for use in cooking, including plant-based or animal-based oils. Such cooking oils may comprise fatty acids, which may be present as free fatty acids or as triglycerides. A wide variety of cooking oils are contemplated for use in the presently described methods. For example, contemplated cooking oils include olive oil, canola oil, sunflower oil, peanut oil, coconut oil, avocado oil, soybean oil, grapeseed oil, sesame oil, corn oil, safflower oil, palm oil, walnut oil, flaxseed oil, rice bran oil, but other cooking oils such as mixed vegetable oils may be utilized.

According to various embodiments, the cooking oil may be “fresh” or “used” cooking oil. “Fresh” cooking oils, as described herein, have not been used in food preparation. “Used” cooking oils, which may also be referred to as “waste” cooking oils, include previously fresh vegetable oils that have been used in food preparation or similarly processed. Used cooking oils may also be referred to as “recycled” cooking oil when the waste cooking oil is then further processed or used in some way. Used cooking oils may be used as a sustainable, inexpensive source of cooking oils utilized in the presently disclosed embodiments. Used cooking oils may be available for purchase, and contain a mixture of cooking oils. In some embodiments, such used cooking oils have been filtered following their use in the cooking, and reference to used cooking oils as described herein generally refers to those that may be filtered to remove non oils such as food particles, which may have been present in a purchased used cooking oil from a third party. Various cooking oils include different chemical compositions, and as such the exact composition of a used cooking oil may not be known by the purchaser, but may include the fatty acids of the named cooking oils.

According to one or more embodiments described herein, crude oil may refer to a naturally occurring mixture of petroleum liquids and gasses. Generally, crude oil may undergo minimal processing before use in the methods described herein, such as removal of impurities such as sulfur and nitrogen. Crude oils are generally distinguished from fractions of crude oil, and have not undergone separation into cuts.

According to one or more embodiments, crude oils contemplated herein include those having an API gravity of from 30° to 38°, such as from 30° to 31°, from 31° to 32°, from 32° to 33°, from 33° to 34°, from 34° to 35°, from 35° to 36°, from 36° to 37°, from 37° to 38°, or any combination of these ranges, such as from 33° to 35°. In some embodiments, the crude oil may comprise, if separated, from 0-5 wt. % gasses with boiling point less than 25° C., from 20-30 wt. % naphtha having boiling points from 25° C. to 200° C., from 25-35 wt. % middle distillate having boiling points from 200° C. to 350° C., and from 40-50 wt. % of atmospheric residue boiling greater than 350° C.

In some embodiments, the crude oil may be Arab Light crude oil. Such Arab Light crude oil may have the properties depicted in Tables 1 and 2.

TABLE 1

| Property | Unit | Value |
|---|---|---|
| API Gravity | degrees | 33.9 |
| Sulfur | wt. % | 1.75 |
| Conradson Carbon Residue | wt. % | 3.83 |
| Hydrogen Sulfide | ppm | 70 |
| Ash | ppm | 20-25 |

TABLE 2

| | Boiling Point | |
|---|---|---|
| Petroleum Fraction | Temperature, ° Celsius | Yield, wt. % |
| Gases | 25 | 1 |
| Naphtha | 25-200 | 25 |
| Middle Distillate | 200-350 | 29 |
| Atmospheric Residue | >350 | 45 |

In one or more embodiments, the hydrocarbon mixture that is cracked may comprise at least 5 wt. % of the cooking oil and at least 5 wt. % of the crude oil. For example, crude oil and cooking oil mixtures of from 95/5 to 5/95 are contemplated, by weight percent, where crude oil and cooking oil are the only oils being cracked.

In one or more embodiments, the hydrocarbon mixture that is cracked may comprise from 1 wt. % to 20 wt. % of the cooking oil. For example, the hydrocarbon mixture that is cracked may comprise from 1 wt. % to 2 wt. %, from 2 wt. % to 3 wt. %, from 3 wt. % to 4 wt. %, from 4 wt. % to 5 wt. %, from 5 wt. % to 6 wt. %, from 6 wt. % to 7 wt. %, from 7 wt. % to 8 wt. %, from 8 wt. % to 9 wt. %, from 9 wt. % to 10 wt. %, from 10 wt. % to 11 wt. %, from 11 wt. % to 12 wt. %, from 12 wt. % to 13 wt. %, from 13 wt. % to 14 wt. %, from 14 wt. % to 15 wt. %, from 15 wt. % to 16 wt. %, from 16 wt. % to 17 wt. %, from 17 wt. % to 18 wt. %, from 18 wt. % to 19 wt. %, from 19 wt. % to 20 wt. %, or any combination of one or more of these ranges, of cooking oil, such as from 5 wt. % to 15 wt. %, from 8 wt. % to 12 wt. %, or from 9 wt. % to 11 wt. %.

In one or more embodiments, the hydrocarbon mixture that is cracked may comprise from 80 wt. % to 99 wt. % of the crude oil. For example, the hydrocarbon mixture that is cracked may comprise from 80 wt. % to 81 wt. %, from 81 wt. % to 82 wt. %, from 82 wt. % to 83 wt. %, from 83 wt. % to 84 wt. %, from 84 wt. % to 85 wt. %, from 85 wt. % to 86 wt. %, from 86 wt. % to 87 wt. %, from 87 wt. % to 88 wt. %, from 88 wt. % to 89 wt. %, from 89 wt. % to 90 wt. %, from 90 wt. % to 91 wt. %, from 91 wt. % to 92 wt. %, from 92 wt. % to 93 wt. %, from 93 wt. % to 94 wt. %, from 94 wt. % to 95 wt. %, from 95 wt. % to 96 wt. %, from 96 wt. % to 97 wt. %, from 97 wt. % to 98 wt. %, from 98 wt. % to 99 wt. %, or any combination of one or more of these ranges, of crude oil, such as from 85 wt. % to 95 wt. %, from 88 wt. % to 92 wt. %, or from 89 wt. % to 91 wt. %.

According to one or more embodiments, the hydrocarbon mixture that is cracked comprises at least 99 wt. % of the crude oil and cooking oil, or may consist of the crude oil and cooking oil.

As described herein, the catalytic cracking of the co-fed crude oil and cooking oil may form a hydrocarbon product, present in stream 120 in the embodiment of FIG. 1. Such a product stream may be subsequently passed to a separation unit such that the hydrocarbon product is divided into various cuts that may be separately utilized downstream or sold. For example, the hydrocarbon product may be separated into at least ethylene, propylene, butenes, BTX aromatics, and fuels. As used in this disclosure, the terms “butenes” and “mixed butenes” refers to 1-butene, cis-2-butene, trans-2-butene, isobutene, and combinations of these. As used in this disclosure, the term “normal butenes” refers to 1-butene, cis-2-butene, trans-2-butene, and any combination thereof, but not including isobutene.

According to one or more embodiments, the hydrocarbon product may comprise at least 25 wt. % of the combination of ethylene, propylene, and butenes (sometimes referred to herein as “light olefins”). For example, the hydrocarbon product may comprise at least 25 wt. %, at least 30 wt. %, at least 35 wt. %, or even at least 40 wt. % of the combination of ethylene, propylene, and butenes. Other components of the hydrocarbon product may include fuel gas (hydrogen and methane), C2-C4 paraffins, naphtha, light cycle oil, heavy cycle oil, and coke. As describe herein, the incorporation of cooking oil into the cracker may unexpectedly increase yield of light olefins.

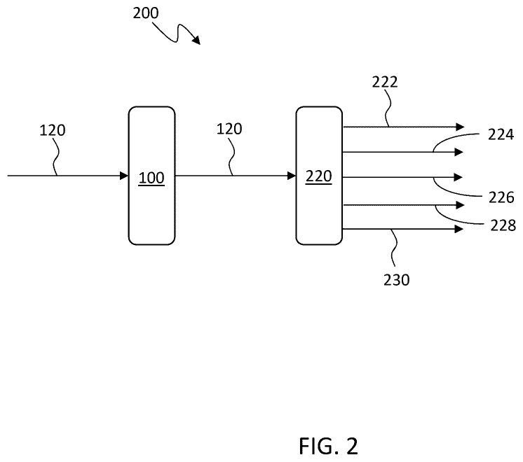

According to additional embodiments, the methods described herein may further comprise separating the hydrocarbon product into multiple cuts. Now referring to FIG. 2, a system 200 is depicted that includes a downstream separation unit 220. The hydrocarbon product may be passed in stream 120 to separation unit 220. As used in this disclosure, a “separation unit” may refer to any separation device or system of separation devices that at least partially separates one or more chemicals that are mixed in a process stream from one another. For example, a separation unit may selectively separate differing chemical species, phases, or sized material from one another, forming one or more chemical fractions. Examples of separation units include, without limitation, distillation columns, flash drums, knock-out drums, knock-out pots, centrifuges, cyclones, filtration devices, traps, scrubbers, expansion devices, membranes, solvent extraction devices, and the like. It should be understood that separation processes described in this disclosure may not completely separate all of one chemical constituent from all of another chemical constituent. It should be understood that the separation processes described in this disclosure “at least partially” separate different chemical components from one another, and that even if not explicitly stated, it should be understood that separation may include only partial separation.

Still referring to FIG. 2, the output of the separation unit 220 may include multiple cuts, passed out of the separation unit as streams 222, 224, 226, 228, and 230. More or less streams exiting the separation unit 220 are contemplated. For example, according to one embodiment, steam 222 may comprise ethylene, stream 224 may comprise propylene, stream 226 may comprise butenes, stream 228 may comprise BTX aromatics, and stream 230 may comprise heavier components such as transportation fuels.

### Examples

The various embodiments of the methods of the present disclosure will be further clarified by the following examples. The examples are illustrative in nature, and should not be understood to limit the subject matter of the present disclosure.

Catalytic cracking was carried out in a fixed-bed micro activity test (MAT) unit (Sakuragi Rikagaku, Japan), using a quartz tubular reactor (I.D. 22 mm, and 38 cm in length).

The used cooking oil was purchased from a dining facility in Saudi Arabia. The compositional information and some properties of the used cooking oil is supplied in Table 3A and the boiling point distribution of the used cooking oil is included in Table 3B. The used cooking oil was filtered and centrifuged to remove all solid particles. Catalyst to oil ratio was 5 in all tests.

The catalyst utilized contained 20 wt. % ZSM-5 zeolite (commercially available as CBV-3024E from Zeolyst International), 21 wt. % USY (ultrastable zeolite Y) (commercially available as CBV-780 from Zeolyst International), 8 wt. % alumina (commercially available as Pural SB Grade from Petrobras), 49 wt. % clay (Kaolin clay commercially available from Petrobras), and 2 wt. % silica (commercially available as Ludox TM40 colloidal silica from DuPont). The ZSM-5 was impregnated at 7.5 wt. % P₂O₅ and USY was impregnated at 2.5 wt. % La₂O₃.

To make the catalyst, the ZSM-5 zeolites were impregnated with phosphorous (utilizing Diammonium hydrogen phosphate commercially available from Sigma Aldrich) and the USY zeolites were impregnated with lanthanum (utilizing Lanthanum Nitrate (III) hydrate commercially available as Fluka from Honeywell). The impregnated zeolites were mixed with alumina binder, silica, and clay and were stirred for 1 hour. The obtained slurry was placed in a temperature programmed oven for drying and calcination. The catalyst was then grounded to fine powder by means of a mortar and a pestle. Finally, the grounded catalyst was sieved for a fraction between 40-120 microns and used for characterization and evaluation.

Table 3C shows some selected properties of the catalyst, such as particle size distribution.

Catalyst was first steam deactivated in a 100% steam environment at 810° C. for 6 h, according to the hydrothermal deactivation treatment in ASTM D4463. A low temperature circulating bath maintained at −10° C. was added to the unit instead of using conventional iced water. All experiments were conducted in the MAT unit at 30 s time-on-stream (TOS). The feed injector and reactor assembly were placed in the heating zone. Before feed injection, the system was purged with N₂ flow at 30 mL/min for about 15 min. Liquid receiver with the product vial was then connected to the bottom of the reactor. The other end of the receiver was connected to the burette for gas collection. A leak test was performed and a low-temperature bath was raised to cover the liquid receiver. The system was continuously purged with N₂ gas for further 15 min.

The reactor was charged with a specified amount of catalyst and about 1 g of various hydrocarbon blends, discussed below, which were fed to the reactor during 30 seconds along with 30 mL/min of N₂ flow. After the reaction, stripping of catalyst was carried out for 5 min using 30 mL/min of N₂ flow. The low-temperature bath was removed and stripping of liquid was continued for three more minutes to remove the gas product dissolved in the liquid. During the reaction and stripping modes gaseous products were collected in a gas burette by water displacement. Weight of the feed syringe was taken before and after experiments to obtain exact weight of oil fed. Catalytic cracking experiments were performed at temperatures of 650° C.

Table 4 shows the product compositions based on three different hydrocarbon feeds—100% used cooking oil, 100% Arab Light crude, and 90 wt. % Arab Light crude and 10 wt. % used cooking oil.

TABLE 3A
Used Cooking Oil Composition and Properties

| | |
|---|---|
| Density, g/mL | 0.9245 |
| API Gravity | 21.6 |
| viscosity (100° C.) [CEA 1001], | 8.41 |
| mm² s⁻¹, cSt | |
| Free Fatty Acid (FFA), wt % | 0.73 |
| Chlorine, ppm | 8 |
| Sulfur, ppm | 1.00 |
| Metal, ppm | 3.81 |
| Ca | 0.50 |
| Fe | 0.02 |
| K | 0.10 |
| Na | 1.06 |
| P | 0.78 |
| Si | 2.13 |
| Sn | 0.06 |
| Zn | 0.17 |

TABLE 3B
Used Cooking Oil Boiling Point Distribution

| | Temp, ° C. |
|---|---|
| IBP | 519 |
| 25 wt. % | 599 |
| 50 wt. % | 607 |
| 75 wt. % | 615 |
| FBP | 632 |

TABLE 3C
Catalyst Properties

| | |
|---|---|
| Crystallinity (%) | 22 |
| Attrition index (%) | 8.4 |
| Surface Area, BET (m²/g) | 285 |
| Particle Size Distribution (PSD) | |
| PSD, 0-20 μm (vol. %) | 2.1 |
| PSD, 0-40 μm (vol. %) | 26.8 |
| PSD, 0-80 μm (vol. %) | 49.6 |
| PSD, 0-149 μm (vol. %) | 100 |

TABLE 4
Product Compositions

| | 100% | 90 wt. % AL crude + | 100% |
|---|---|---|---|
| Feed | UCO | 10% wt. % UCO | AL Crude |
| Fuel Gas (wt. %) | 3.55 | 4.9 | 3.31 |
| C2-C4 paraffins (wt. %) | 6.92 | 7.41 | 6.41 |
| Ethylene (wt. %) | 12.13 | 9.47 | 8.27 |
| Propylene (wt. %) | 25.24 | 20.03 | 17.48 |
| Butenes (wt. %) | 12.59 | 11.14 | 9.74 |
| Naphtha (wt. %) | 30.16 | 32.37 | 33.95 |
| LCO (wt. %) | 5.92 | 7.73 | 12.72 |
| HCO (wt. %) | 1.56 | 2.55 | 2.66 |
| Coke (wt. %) | 1.92 | 4.4 | 5.47 |
| Conversion % | 95.52 | 89.72 | 84.62 |
| C2-C4 olefins (wt. %) | 49.96 | 40.64 | 35.49 |

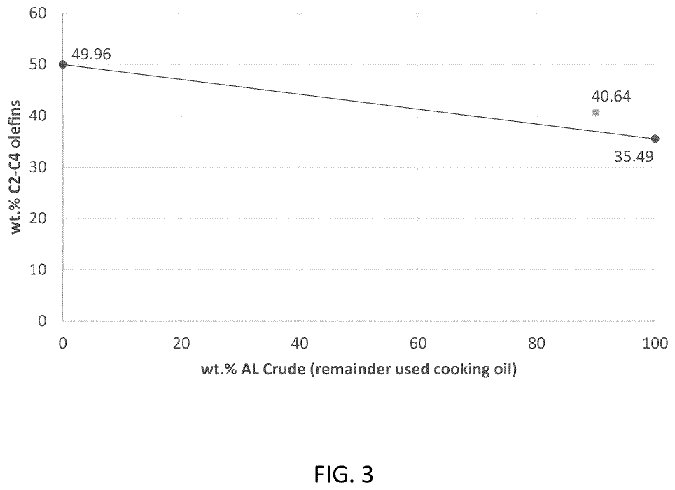

The data shows that light olefins are more prevalent in products of cracked cooking oils as compared to Arab Light crude. However, when the two are mixed, more light olefins are produced that would be expected. This result is depicted in FIG. 3. FIG. 3 graphically shows the light olefin percentage from cracking cooking oil and crude oil, marked at 0 and 100 on the x axis. The dotted line depicts the expected amount of light olefin that would be produced as the ratio of crude oil to cooking oil changed. However, the light olefin formation for 90/10 blend is much greater than predicted by simply mixing the two feeds.

Numerous technical aspects are disclosed herein, which are described below as Aspects 1-20.
Aspect 1. A method for co-processing crude oil and cooking oil, the method comprising: catalytically cracking a hydrocarbon mixture to form hydrocarbon product, wherein the hydrocarbon mixture comprises: from 1 wt. % to 20 wt. % of cooking oil; and from 80 wt. % to 99 wt. % of crude oil having an API gravity of from 30° to 38°; wherein the hydrocarbon product comprises ethylene, propylene, and butenes.
Aspect 2. The method of claim 1, wherein the crude oil has an API gravity of from 33° to 35°.
Aspect 3. The method of any previous Aspect, wherein the cracking is in the presence of a catalyst that comprises ZSM-5 zeolite and zeolite-Y.
Aspect 4. The method of Aspect 3, wherein the catalyst further comprise silica, alumina, and clay.
Aspect 5. The method of Aspect 4, wherein the catalyst comprises, based on the total weight of the catalyst: from 5 wt. % to 50 wt. % of the ZSM-5 zeolite; from 5 wt. % to 50 wt. % of the zeolite-Y; from 0.5 wt. % to 10 wt. % of the silica; from 2 wt. % to 20 wt. % of the alumina; and from 30 wt. % to 60 wt. % of the clay.
Aspect 6. The method of any previous Aspect, wherein the crude oil comprises: 0-5 wt. % gasses with boiling point less than 25° C.; from 20-30 wt. % naphtha having boiling points from 25° C. to 200° C.; from 25-35 wt. % middle distillate having boiling points from 200° C. to 350° C.; and from 40-50 wt. % of atmospheric residue boiling greater than 350° C.
Aspect 7. The method of any previous Aspect, wherein the cooking oil is a used cooking oil that has been used in food preparation.
Aspect 8. The method of any previous Aspect, wherein the cooking oil comprises olive oil, canola oil, sunflower oil, peanut oil, coconut oil, avocado oil, soybean oil, grapeseed oil, sesame oil, corn oil, safflower oil, palm oil, walnut oil, flaxseed oil, rice bran oil, or combinations thereof.
Aspect 9. The method of any previous Aspect, wherein the cracking is fluidized catalytic cracking.
Aspect 10. The method of any previous Aspect, wherein the cracking is at a temperature of from 600° C. to 700° C.
Aspect 11. The method of any previous Aspect, wherein the catalyst to oil mass ratio is from 40:1 to 1:1
Aspect 12. The method of any previous Aspect, wherein the hydrocarbon mixture comprises at least 99 wt. % of the cooking oil and the crude oil.
Aspect 13. The method of any previous Aspect, wherein the hydrocarbon mixture consists of the cooking oil and the crude oil.
Aspect 14. The method of any previous Aspect, wherein the hydrocarbon product comprises at least 20 wt. % of the combination of ethylene, propylene, and butenes.
Aspect 15. The method of any previous Aspect, wherein the hydrocarbon mixture comprises: from 5 wt. % to 15 wt. % of cooking oil; and from 85 wt. % to 95 wt. % of the crude oil having an API gravity of from 30° to 38°.

For the purposes of describing and defining the present disclosure it is noted that the terms “about” or “approximately” are utilized in this disclosure to represent the inherent degree of uncertainty that may be attributed to any quantitative comparison, value, measurement, or other representation. The terms “about” and/or “approximately” are also utilized in this disclosure to represent the degree by which a quantitative representation may vary from a stated reference without resulting in a change in the basic function of the subject matter at issue.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

Any quantitative value expressed in the present application may be considered to include open-ended embodiments consistent with the transitional phrases “comprising” or “including” as well as closed or partially closed embodiments consistent with the transitional phrases “consisting of” and “consisting essentially of.” It is also noted that recitations herein of “at least one” component, element, etc., should not be used to create an inference that the alternative use of the articles “a” or “an” should be limited to a single component, element, etc. It is also noted that recitations herein of “at least” followed by a quantitative value should be understood as being equivalent to “greater than or equal to” the quantitative value.

1. A method for co-processing crude oil and cooking oil, the method comprising:
catalytically cracking a hydrocarbon mixture to form hydrocarbon product, wherein the hydrocarbon mixture comprises:
from 1 wt. % to 20 wt. % of cooking oil; and
from 80 wt. % to 99 wt. % of crude oil having an API gravity of from 30° to 38°;
wherein the hydrocarbon product comprises ethylene, propylene, and butenes.

2. The method of claim 1, wherein the crude oil has an API gravity of from 33° to 35°.

3. The method of claim 1, wherein the cracking is in the presence of a catalyst that comprises ZSM-5 zeolite and zeolite-Y.

4. The method of claim 3, wherein the catalyst further comprise silica, alumina, and clay.

5. The method of claim 4, wherein the catalyst comprises, based on the total weight of the catalyst:
from 5 wt. % to 50 wt. % of the ZSM-5 zeolite;
from 5 wt. % to 50 wt. % of the zeolite-Y;
from 0.5 wt. % to 10 wt. % of the silica;
from 2 wt. % to 20 wt. % of the alumina; and
from 30 wt. % to 60 wt. % of the clay.

6. The method of claim 1, wherein the crude oil comprises:
0-5 wt. % gasses with boiling point less than 25° C.;
from 20-30 wt. % naphtha having boiling points from 25° C. to 200° C.;
from 25-35 wt. % middle distillate having boiling points from 200° C. to 350° C.; and
from 40-50 wt. % of atmospheric residue boiling greater than 350° C.

7. The method of claim 1, wherein the cooking oil is a used cooking oil that has been used in food preparation.

8. The method of claim 1, wherein the cooking oil comprises olive oil, canola oil, sunflower oil, peanut oil, coconut oil, avocado oil, soybean oil, grapeseed oil, sesame oil, corn oil, safflower oil, palm oil, walnut oil, flaxseed oil, rice bran oil, or combinations thereof.

9. The method of claim 1, wherein the cracking is fluidized catalytic cracking.

10. The method of claim 1, wherein the cracking is at a temperature of from 600° C. to 700° C.

11. The method of claim 1, wherein the catalyst to oil mass ratio is from 40:1 to 1:1.

12. The method of claim 1, wherein the hydrocarbon mixture comprises at least 99 wt. % of the cooking oil and the crude oil.

13. The method of claim 1, wherein the hydrocarbon mixture consists of the cooking oil and the crude oil.

14. The method of claim 1, wherein the hydrocarbon product comprises at least 20 wt. % of the combination of ethylene, propylene, and butenes.

15. The method of claim 1, wherein the hydrocarbon mixture comprises:
from 5 wt. % to 15 wt. % of cooking oil; and
from 85 wt. % to 95 wt. % of the crude oil having an API gravity of from 30° to 38°.

16. The method of claim 1, wherein:
the crude oil is Arab Light crude oil;
the cooking oil is a used cooking oil that has been used in food preparation; and
the hydrocarbon mixture comprises:
from 5 wt. % to 15 wt. % of the used cooking oil; and
from 85 wt. % to 95 wt. % of the Arab Light crude oil.

17. The method of claim 16, wherein the cooking oil comprises olive oil, canola oil, sunflower oil, peanut oil, coconut oil, avocado oil, soybean oil, grapeseed oil, sesame oil, corn oil, safflower oil, palm oil, walnut oil, flaxseed oil, rice bran oil, or combinations thereof.

18. The method of claim 16, wherein the cracking is fluidized catalytic cracking.

19. The method of claim 16, wherein the cracking is at a temperature of from 600° C. to 700° C.

20. The method of claim 16, wherein the catalyst to oil mass ratio is from 10:1 to 1:1.
